(19) United States
(12) Patent Application Publication
(10) Pub. No.: US 2025/0247831 A1
(43) Pub. Date: Jul. 31, 2025

(54) BASE STATION, TERMINAL, AND COMMUNICATION METHOD

(71) Applicant: Panasonic Intellectual Property Corporation of America, Torrance, CA (US)

(72) Inventors: Tomoya NUNOME, Ishikawa (JP); Quan KUANG, Langen (DE); Hidetoshi SUZUKI, Kanagawa (JP)

(21) Appl. No.: 18/848,302

(22) PCT Filed: Feb. 14, 2023
(86) PCT No.: PCT/JP2023/005052

§ 371 Date: Sep. 18, 2024

(30) Foreign Application Priority Data
Mar. 30, 2022 (JP) 2022-056373

(51) Int. Cl. H04W 72/0453; H04L 5/00

(52) U.S. Cl. CPC H04W 72/0453; H04L 5/0053; H04L 5/0094

(57) ABSTRACT

The base station comprises: a control circuit that sets allocation resources to be allocated to signals of a terminal within one of a plurality of bands, in a method in which transmission directions are individually set for a plurality of bands obtained by dividing a frequency band; and a communication circuit that either transmits or receives a signal using the allocation resources.

### TECHNICAL FIELD

The present disclosure relates to a base station, a terminal, and a communication method.

### BACKGROUND ART

In 3rd Generation Partnership Project (3GPP), the specification of the PHY layer in Release 17 New Radio access technology (NR) has been completed as functional extension of 5th Generation mobile communication systems (5G). NR supports functions for realizing Ultra Reliable and Low Latency Communication (URLLC) in addition to enhanced Mobile Broadband (eMBB) to satisfy requirements of high speed and high capacity (see, e.g., Non-Patent Literatures (hereinafter referred to as “NPLs”) 1 to 5).

### CITATION LIST

### Non-Patent Literature

NPL 1

3GPP TS 38.211 V17.0.0, “NR; Physical channels and modulation (Release 17),” December 2021

NPL 2

3GPP TS 38.212 V17.0.0, “NR; Multiplexing and channel coding (Release 17),” December 2021

NPL 3

3GPP TS 38.213 V17.0.0, “NR; Physical layer procedure for control (Release 17),” December 2021

NPL 4

3GPP TS 38.214 V17.0.0, “NR; Physical layer procedures for data (Release 17),” December 2021

NPL 5

3GPP TS 38.215 V17.0.0, “NR; Physical layer measurements (Release 17),” December 2021

NPL 6

3GPP TS 38.331 V16.7.0, “NR; Radio Resource Control (RRC) protocol specification (Release 16)”, December 2021

### SUMMARY OF INVENTION

However, there is room for further study on resource allocation in a radio communication.

One non-limiting and exemplary embodiment facilitates providing a base station, a terminal, and a communication method each capable of appropriately performing resource allocation.

A base station according to one exemplary embodiment of the present disclosure includes: control circuitry, which, in operation, configures an allocation resource within one band of a plurality of bands into which a frequency band is divided, in a system in which a transmission direction is individually configured for each of the plurality of bands, the allocation resource being allocated for a signal of a terminal; and communication circuitry, which, in operation, performs either transmission or reception of the signal using the allocation resource.

It should be noted that general or specific embodiments may be implemented as a system, an apparatus, a method, an integrated circuit, a computer program, a storage medium, or any selective combination thereof.

According to an exemplary embodiment of the present disclosure, it is possible to appropriately perform resource allocation.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates examples of a duplex system;

FIG. 2 illustrates an example of a resource block (RB) set;

FIG. 3 illustrates a configuration example of a Bandwidth part (BWP);

FIG. 4 is a block diagram illustrating an exemplary configuration of a part of a base station;

FIG. 5 is a block diagram illustrating an exemplary configuration of a part of a terminal;

FIG. 6 is a block diagram illustrating an exemplary configuration of the base station;

FIG. 7 is a block diagram illustrating an exemplary configuration of the terminal;

FIG. 8 is a sequence diagram illustrating exemplary operations of the base station and the terminal;

FIG. 9 illustrates an example of the position of a terminal;

FIG. 10 illustrates a configuration example of allocation resources for the terminal;

FIG. 11 illustrates an example of a beam direction;

FIG. 12 illustrates an exemplary architecture of a 3GPP NR system;

FIG. 13 is a schematic diagram illustrating functional split between Next Generation-Radio Access Network (NG-RAN) and 5th Generation Core (5GC);

FIG. 14 is a sequence diagram of a Radio Resource Control (RRC) connection setup/reconfiguration procedure;

FIG. 15 is a schematic diagram illustrating usage scenarios of enhanced Mobile BroadBand (eMBB), massive Machine Type Communications (mMTC), and Ultra Reliable and Low Latency Communications (URLLC); and

FIG. 16 is a block diagram illustrating an exemplary 5G system architecture for a non-roaming scenario.

### DESCRIPTION OF EMBODIMENTS

Hereinafter, embodiments of the present disclosure will be described in detail with reference to the accompanying drawings.

### Cross Division Duplex (XDD)

“Study on evolution of NR duplex operation” was approved as a Study Item for Release 18. One of the main topics of the Study Item is the support for subband non-overlapping full duplex (also referred to as Cross Division Duplex (XDD)).

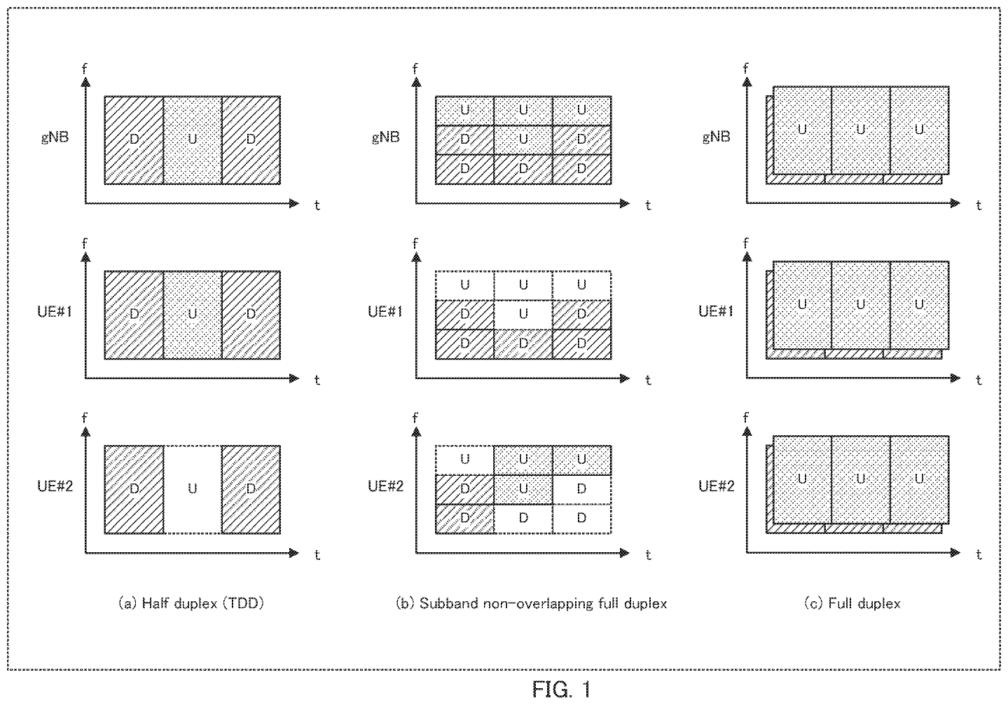

Parts (a) to (c) in FIG. 1 illustrate examples of a Duplex system. In parts (a) to (c) in FIG. 1, the vertical axis represents frequency, and the horizontal axis represents time. Further, “U” indicates uplink transmission and “D” indicates downlink transmission in parts (a) to (c) in FIG. 1.

Part (a) in FIG. 1 illustrates an example of Time Division Duplex (TDD) in half duplex. In part (a) in FIG. 1, terminal (for example, also referred to as user equipment (UE)) #1 and UE #2 are terminals connected to a base station (for example, also referred to as gNB). For example, the base station may determine the transmission direction (for example, downlink or uplink) for each time resource and indicate it to the terminal. Note that there may be a case where a terminal does not use a resource in the transmission direction in a certain time resource (for example, a resource indicated by a broken line in parts (a) to (c) in FIG. 1). In the half duplex illustrated in part (a) in FIG. 1, the transmission direction in a certain time resource may be common among terminals. For example, the transmission direction is not different between terminals in a certain time resource. For example, in a time resource in which UE #1 performs uplink transmission, UE #2 does not perform downlink reception.

Part (b) in FIG. 1 illustrates an example of XDD. In XDD, a frequency resource (or frequency band) is divided into multiple bands (for example, subbands), and transmission in different directions (for example, downlink or uplink) on a subband-by-subband basis is supported. Note that, in XDD, a terminal performs either uplink or downlink transmission and reception in a certain time resource, and does not perform transmission and reception of the other. In contrast, in XDD, the base station can simultaneously transmit and receive both the uplink and the downlink.

Part (c) in FIG. 1 illustrates an example of Overlapping full duplex (simply referred to as full duplex). In full duplex, both the base station and the terminal can simultaneously transmit and receive the uplink and the downlink in frequency and time resources.

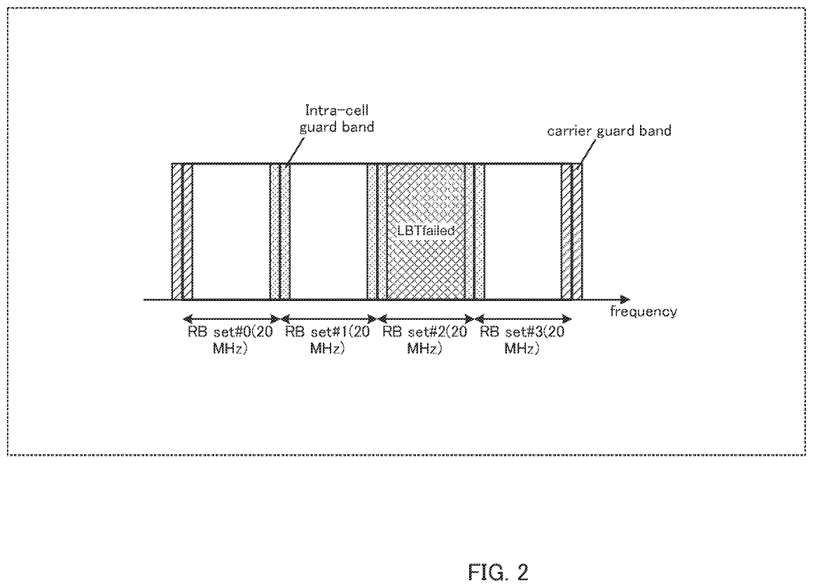

Here, as illustrated in part (b) in FIG. 1, the frequency resource may be divided to realize XDD. Here, one of the methods for dividing a frequency resource in an existing standard is the resource block (RB) set. For example, in NR-U of Release 16 (hereinafter, Rel. 16), an RB set was introduced to divide the band in accordance with a carrier sensing (for example, Listen Before Talk (LBT)), with the band having a bandwidth of, for example, 20 MHz. FIG. 2 illustrates an example of an RB set in an unlicensed band of frequency range 1 (FR1). In the example illustrated in FIG. 2, an 80 MHz band is divided into four RB sets (RB sets #0 to #3), each having a 20 MHz bandwidth.

For example, in FIG. 2, utilization by different radio systems is also assumed for each of the plurality of RB sets. For this reason, as illustrated in FIG. 2, a guard band (for example, an intra-cell guard band) may be placed between RB sets. By placing the guard band in this manner, cross link interference (CLI) can be reduced.

For example, the method for realizing XDD using an RB set has not been thoroughly examined.

In a non-limiting embodiment of the present disclosure, a method for realizing XDD using an RB set is described, for example.

### About RB Set and Bandwidth Part (BWP)

When a terminal performs transmission and reception using a plurality of RB sets as subbands for XDD, there is a possibility that the configuration of the terminal becomes complicated.

For example, even if the plurality of RB sets are assigned for the terminal, there is a possibility that the terminal uses a part of the RB sets for transmission and reception at certain timing and does not use the remaining RB sets. The number or positions of the RB sets used for transmission and reception by the terminal may change dynamically.

At this time, the band to which a radio frequency (RF) filter is applied may be dynamically changed according to the RB set used by the terminal in order to reduce interference from outside the RB set used by the terminal, for example. In this case, the realization of rapid switching of the RF filter is expected in the terminal, and thus, the configuration of the terminal may become complicated.

Further, for example, the dynamic placement of guard bands may be required according to the transmission direction (for example, Downlink and Uplink) of each RB set. For example, in addition to the presence or absence of the guard band, the size of the guard band may also be changed according to Cross link interference (CLI).

Here, the resource where the guard band is placed is not used for data transmission. For this reason, processing such as rate matching may be performed to exclude the resource of the guard band during data transmission and reception.

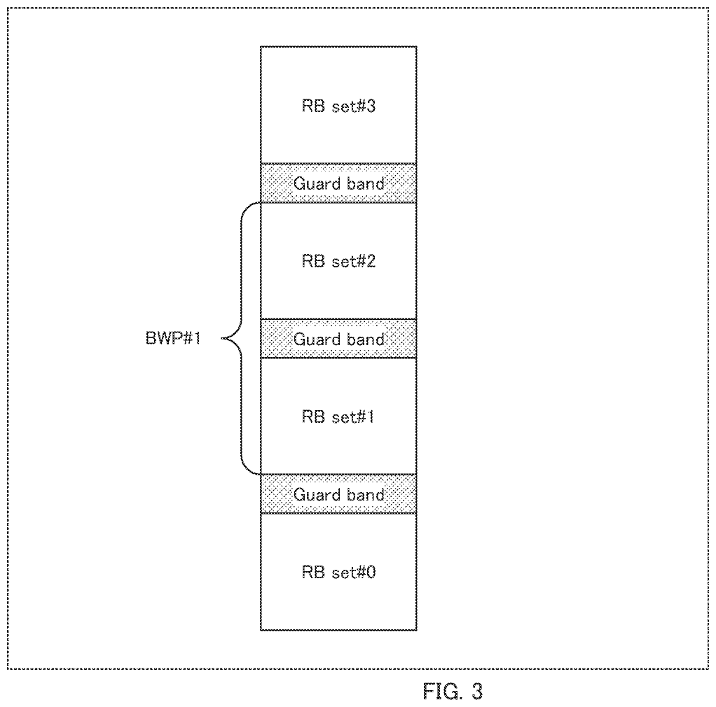

For example, in the existing standards, a bandwidth part (BWP), which is a band used for communication by a terminal, is defined as being constituted by one or more RB sets. Further, the boundaries of the BWP and the RB set are defined to coincide. FIG. 3 illustrates an example of the relationship between the BWPs and the RB sets. In the example illustrated in FIG. 3, four RB sets, namely RB set #0 to RB set #3, are allocated to the system band, and RB set #1 and RB set #2 are configured as BWP #1 for the terminal. As illustrated in FIG. 3, the boundary of BWP #1 coincides with the boundaries of RB set #1 and RB set #2 (excluding guard bands).

In a non-limiting and exemplary embodiment of the present disclosure, a method for configuring an allocation resource (for example, BWP) to which a signal of the terminal is allocated in the case of realizing XDD using a plurality of RB sets will be described. According to the non-limiting and exemplary embodiment of the present disclosure, it is possible to configure an allocation resource appropriately and to prevent a terminal configuration from becoming complicated.

### Overview of Communication System

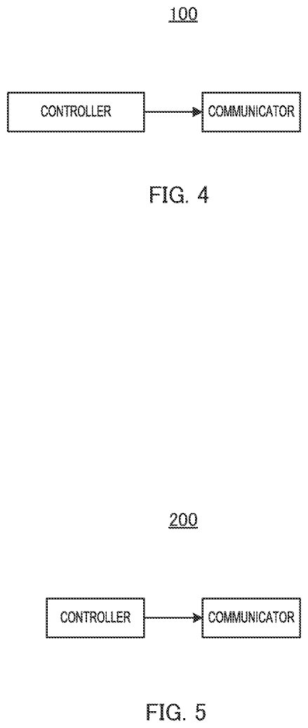

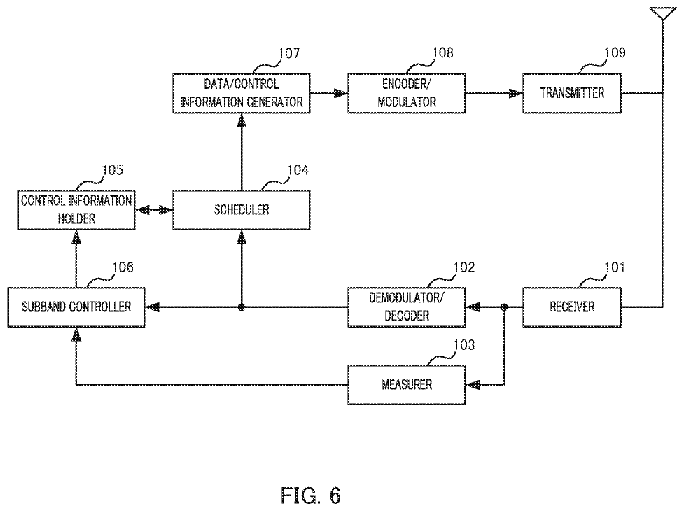

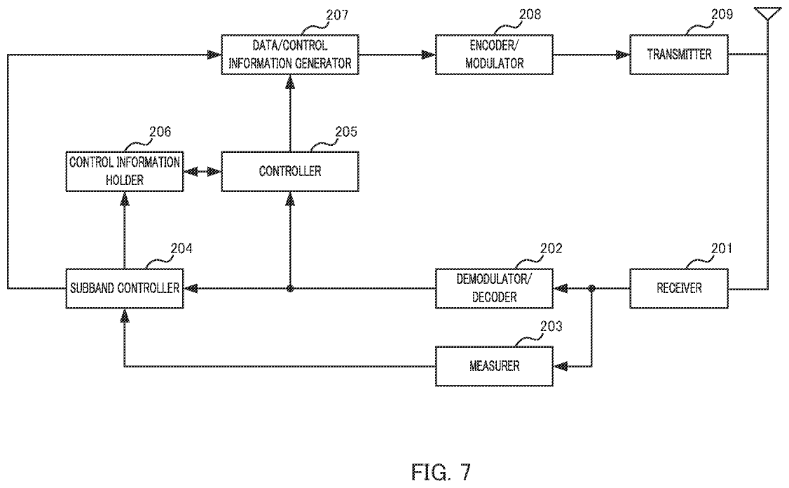

A communication system according to an aspect of the present disclosure may include, for example, base station 100 (for example, gNB) illustrated in FIGS. 4 and 6 and terminal 200 (for example, UE) illustrated in FIGS. 5 and 7. The communication system may include a plurality of base stations 100 and a plurality of terminals 200.

FIG. 4 is a block diagram illustrating an exemplary configuration of a part of base station 100 according to an aspect of the present disclosure. In base station 100 illustrated in FIG. 4, the controller (for example, corresponding to control circuitry) configures the allocation resource, to which a signal of a terminal is allocated, within one band of a plurality of bands (for example, subbands or RB sets) in a manner where the transmission direction is individually configured for each of the plurality of bands into which the frequency band is divided. The transmitter (corresponding to, for example, transmission circuitry) performs either transmission or reception of a signal using the allocation resource.

FIG. 5 is a block diagram illustrating an exemplary partial configuration of terminal 200 according to the aspect of the present disclosure. In terminal 200 illustrated in FIG. 5, the controller (for example, corresponding to control circuitry) configures the allocation resource, to which a signal is allocated, within one band of a plurality of bands (for example, subbands or RB sets) in a manner where the transmission direction is individually configured for each of the plurality of bands into which the frequency band is divided. The communicator (corresponding to, for example, communication circuitry) performs either transmission or reception of a signal using the allocation resource.

### Configuration of Base Station

FIG. 6 is a block diagram illustrating an exemplary configuration of base station 100 according to an aspect of the present disclosure. In FIG. 6, base station 100 includes receiver 101, demodulator/decoder 102, measurer 103, scheduler 104, control information holder 105, subband controller 106, data/control information generator 107, encoder/modulator 108, and transmitter 109.

Note that, for example, at least one of demodulator/decoder 102, measurer 103, scheduler 104, control information holder 105, subband controller 106, data/control information generator 107, and encoder/modulator 108 may be included in the controller illustrated in FIG. 4, and at least one of receiver 101 and transmitter 109 may be included in the communicator illustrated in FIG. 4.

For example, receiver 101 performs reception processing such as down-conversion or A/D conversion on the received signal received via the antenna, and outputs the received signal after the reception processing to demodulator/decoder 102 and measurer 103.

For example, demodulator/decoder 102 demodulates and decodes the received signal (for example, uplink signal) inputted from receiver 101 and outputs the decoding result to scheduler 104. Further, when, for example, a report from terminal 200 is included in the decoding result, demodulator/decoder 102 outputs the report to subband controller 106.

The report may include information used for subband allocation, such as UE capability, a CLI measurement result, and a transmission buffer amount.

Measurer 103 measures parameters used for subband control based on signals inputted from, for example, receiver 101, and outputs the measurement results to subband controller 106.

Scheduler 104 may perform scheduling for terminal 200, for example. Further, scheduler 104 performs scheduling of reception and transmission of terminal 200 based on at least one of the decoding result inputted from demodulator/decoder 102 and the subband information inputted from control information inputted from control information holder 105, and indicates generation of at least one of data or control information to data/control information generator 107.

Control information holder 105 holds control information configuration for each terminal 200, for example. The control information may include information relating to the assignment of subbands for each terminal 200 (for example, subband information). For example, control information holder 105 may output the held information to each component (for example, scheduler 104) of base station 100 as needed.

Subband controller 106 determines the subband allocation for each terminal 200 and the Active subband, for example, based on at least one of a report from terminal 200 inputted from demodulator/decoder 102, and a measurement result inputted from measurer 103, and outputs the determined information (subband information) to control information holder 105.

For example, data/control information generator 107 generates at least one of data and control information in accordance with the instruction from scheduler 104 and outputs a signal including the generated data or control information to encoder/modulator 108. Note that the generated data and control information may include, for example, at least one of signaling information of the higher layer (for example, information on subband allocation), downlink control information (for example, information on the Active subband), and report request for terminal 200.

Encoder/modulator 108 encodes and modulates, for example, the signal inputted from data/control information generator 107 and outputs the modulated signal to transmitter 109.

Transmitter 109 performs transmission processing such as D/A conversion, up-conversion, or amplification on the signal inputted from encoder/modulator 108, for example, and transmits a radio signal obtained by the transmission processing to terminal 200 through the antenna.

### Configuration of Terminal

FIG. 7 is a block diagram illustrating an exemplary configuration of terminal 200 according to an aspect of the present disclosure. In FIG. 7, terminal 200 includes receiver 201, demodulator/decoder 202, measurer 203, subband controller 204, controller 205, control information holder 206, data/control information generator 207, encoder/modulator 208, and transmitter 209.

Note that, for example, at least one of demodulator/decoder 202, measurer 203, subband controller 204, controller 205, control information holder 206, data/control information generator 207, and encoder/modulator 208 may be included in the controller illustrated in FIG. 5, and at least one of receiver 201 and transmitter 209 may be included in the communicator illustrated in FIG. 5.

For example, receiver 201 performs reception processing such as down-conversion or A/D conversion on the received signal received via the antenna, and outputs the received signal after the reception processing to demodulator/decoder 202 and measurer 203.

For example, demodulator/decoder 202 demodulates and decodes the received signal inputted from receiver 201 and outputs a decoding result to subband controller 204 and controller 205. The decoding result may include, for example, signaling information of a higher layer and downlink control information.

Measurer 203 measures parameters (for example, CLI or transmission buffer amount) used for subband control (or report creation) based on signals inputted from receiver 201, and outputs the measurement results to subband controller 204.

Subband controller 204 determines (or identifies, specifies, or decides) the subband allocation and the Active subband based on, for example, the signaling information or the downlink control information inputted from demodulator/decoder 202, and outputs the determined information to control information holder 206. Further, subband controller 204 creates a report (for example, including information to be used for subband allocation such as UE capability, CLI measurement result, transmission buffer amount, and the like) based on the measurement results inputted from, for example, measurer 203, and outputs information on the created report to data/control information generator 207. Note that subband controller 204 may create a report in accordance with a report request from, for example, base station 100.

Controller 205 may determine, based on control information inputted from control information holder 206 or a decoding result inputted from demodulator/decoder 202 (for example, data or control information), whether to perform feedback for a downlink reception or whether to perform an uplink transmission. Further, as a result of the determination, in a case where there is transmission of data or control information, controller 205 may indicate generation of at least one of the data and the control information to data/control information generator 207, for example.

Control information holder 206, for example, holds the control information inputted from subband controller 204 and controller 205, and outputs the held information to each component (for example, controller 205) as needed.

For example, data/control information generator 207 generates data or control information in accordance with the indication from controller 205 and outputs a signal including the generated data or control information to encoder/modulator 208. Note that the generated data may include information on a report inputted from the subband controller 204.

Encoder/modulator 208 encodes and modulates, for example, the signal inputted from data/control information generator 207 and outputs the modulated transmission signal to transmitter 209.

Transmitter 209 performs transmission processing such as D/A conversion, up-conversion, or amplification on the signal inputted from encoder/modulator 208, for example, and transmits a radio signal obtained by the transmission processing through the antenna to base station 100.

### Operations of Base Station 100 and Terminal 200

Exemplary operations of base station 100 and terminal 200 having the above configurations will be described.

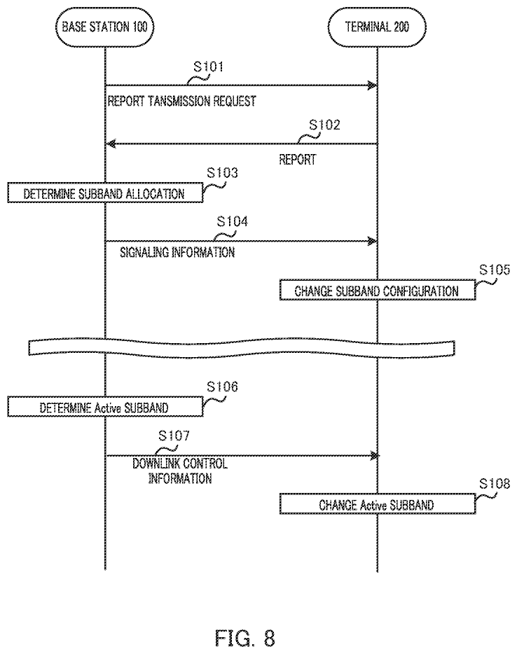

FIG. 8 is a sequence diagram illustrating an exemplary operation of base station 100 and terminal 200.

In FIG. 8, base station 100 requests terminal 200 to transmit a report including information such as the UE capability, the CLI measurement result, and the transmission buffer amount to be used for subband allocation (S101). Note that the information used for subband allocation is not limited to the UE capability, the CLI measurement result, and the transmission buffer amount, and may include other information.

Terminal 200 generates a report and transmits the report in response to, for example, a report transmission request from base station 100 (S102).

Base station 100 determines a subband (for example, RB set) to assign for terminal 200, for example, based on the report from terminal 200 (S103).

Note that base station 100 may determine the subband allocation for terminal 200 based on the determination of base station 100 without using a report from terminal 200 (for example, without performing the processing of S101 and S102).

Base station 100 transmits signaling information of a higher layer, including information on a subband allocated for terminal 200 (subband information), to terminal 200, for example (S104). Note that the signaling information may be, for example, broadcast information and may be indicated to a plurality of terminals 200.

Terminal 200 changes the subband configuration, such as the number of subbands, the RB positions, or the number of RBs in each subband, based on the subband information included in the signaling information from base station 100, for example (S105). The subband configuration may be realized, for example, by configuring a BWP and configuring an RB set.

Base station 100 determines, for example, an Active subband among the subbands allocated for terminal 200 in accordance with the communication state of each terminal 200 (for example, CLI or traffic amount) or the resource usage state in each subband (S106). Base station 100 indicates the switching of the Active subband using downlink control information to terminal 200, for example (S107). Note that the signal used for indicating the Active subband is not limited to downlink control information and may also be, for example, signaling of a higher layer (signaling of Medium Access Control (MAC) and Radio Resource Control (R.R.C)).

Terminal 200 performs the configuration (or change/switch) of the Active subband in accordance with information on the Active subband indicated by the base station, for example (S108). Note that the switching of the Active subband may be realized, for example, by switching the Active BWP.

### Subband Allocation Method

An example of a method for allocating a subband in base station 100 (for example, subband controller 106) will be described. Note that terminal 200 (for example, subband controller 204) may configure the subband by assuming the subband allocation performed by base station 100, for example.

### Allocation Method 1

In allocation method 1, base station 100 configures the frequency band (for example, the allocation resource or the frequency resource) allocated to the signal of terminal 200 within one subband of multiple subbands (for example, a plurality of RB sets). For example, base station 100 limits the frequency band allocated to the signal of terminal 200 within a subband. For example, the frequency band allocated to the signal of terminal 200 may be both the uplink and downlink frequency bands, or it may be one of them.

For example, base station 100 may configure (for example, limit) the range of the BWP allocated for terminal 200 (for example, RB used for BWP) within one RB set. For example, all RBs within one RB set may be allocated to the BWP, or only some RBs within the RB set may be allocated to the BWP.

Note that, although the RB set is introduced for Release 16 NR-U, the RB set may be applied to the license band in an exemplary embodiment of the present disclosure. Further, the bandwidth of the RB set is not necessarily limited to the LBT bandwidth (for example, 20 MHz).

As described above, the guard band may be configured between RB sets. According to allocation method 1, BWP is configured (for example, limited) within one RB set, and thus, the guard band is placed outside BWP and is not placed within BWP. For this reason, terminal 200 does not need to be conscious of the guard band in communication using the BWP.

Further, for example, as illustrated in part (b) in FIG. 1, the transmission directions (for example, Downlink and Uplink) are individually configuration for subbands (for example, RB sets) at the same timing. According to allocation method 1, BWP is configured (for example, limited) within one RB set, and thus, BWP corresponds to either the downlink or the uplink at the same timing, and the downlink and uplink do not mix within BWP. For this reason, it is not necessary to limit, for example, within the BWP, the band to which the RF filter is applied, and the RF filter can be activated in all bands within the BWP.

Further, according to allocation method 1, since BWP is configured (for example, limited) within one RB set, terminal 200 need not change the application of the guard band and the RF filter, for example, in accordance with the transmission direction in an RB set different from the RB set which terminal 200 is assigned for.

As described above, according to allocation method 1, BWP is configured within one RB set, and thus, it is possible to prevent the processing (for example, a rate matching process or the like) from becoming complicated due to the configuration of the guard band or the RF filter, and it is possible to achieve XDD with a simple configuration of terminal 200.

Here, one subband (for example, RB set) allocated for terminal 200 may be configured from among multiple subbands according to a characteristic of terminal 200 (for example, position, beam, or traffic). For example, base station 100 may group (or classify) terminals 200 according to the characteristics of terminals 200 and allocate the same subband for terminals 200. Hereinafter, an example of the classification method for classifying terminals 200 will be described.

### Classification Method 1

In classification method 1, subbands (for example, RB sets) allocated for terminal 200 may be classified in accordance with the position of terminal 200. For example, base station 100 may classify terminal 200 based on whether terminal 200 is located at a cell edge or at a cell center. For example, base station 100 may group terminals 200 with similar positions within the cell and allocate the same RB set for grouped terminals 200.

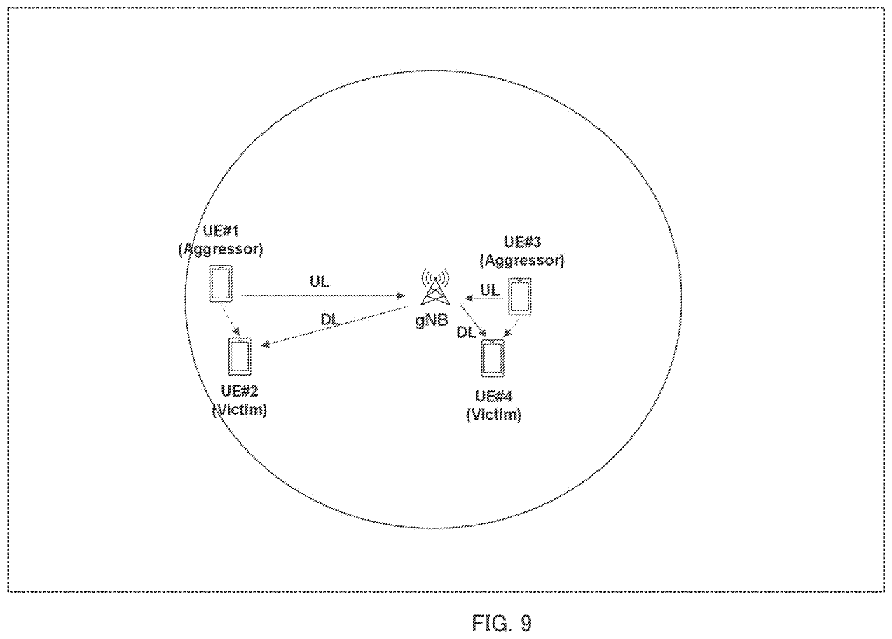

FIG. 9 illustrates an example of the positions of terminals 200. In FIG. 9, UE #1 and UE #2 represent terminals 200 (for example, also referred to as cell edge terminals) located at the cell edge, and UE #3 and UE #4 represent terminals 200 (for example, also referred to as cell center terminals) located at the cell center.

The cell edge terminals have a larger path loss between the base station 100 (gNB) and terminal 200 (UE) compared to the cell center terminals. For this reason, the downlink received power at the cell edge terminals is likely to decrease compared to the downlink received power at the cell center terminals. For example, in FIG. 9, the received power of UE #2 is smaller than the received power of UE #4.

On the other hand, the uplink transmission power at the cell edge terminals is likely to increase, for example, to compensate for path loss, in comparison with the uplink transmission power at the cell center terminals. For example, in FIG. 9, the transmission power of UE #1 is greater than the transmission power of UE #3.

For this reason, in a case where the cell edge terminal (for example, UE #2) receives a downlink signal within a certain RB set and another cell edge terminal (for example, UE #1) transmits an uplink signal in an RB set that is adjacent to the RB set, the influence of CLI of the uplink transmission on the downlink reception is likely to be large as compared to the cell center terminal (for example, UE #4). In contrast, in the cell center terminal (for example, UE #4), the path loss between base station 100 and terminal 200 is small, and thus, the influence of CLI is small compared to that for the cell edge terminal.

Further, in the cell center terminal, the propagation delay between base station 100 and terminal 200 is smaller than that in the cell edge terminal. For this reason, in a case where the cell center terminal (for example, UE #4) receives a downlink signal within a certain RB set and another cell center terminal (for example, UE #3) transmits an uplink signal in an RB set that is adjacent to the certain RB set, the reception timing difference between the downlink signal and the uplink signal may be within a cyclic prefix (CP) from the viewpoint of the cell center terminal (for example, UE #4) that receives the downlink signal. When the reception timing difference between the downlink signal and the uplink signal is within the CP, inter-subcarrier interference can be reduced, and thus, CLI can be reduced.

Thus, in classification method 1, the BWP for terminal 200, whose position from the center of the cell is within a threshold range, may for example be configured in the same RB set. For example, the BWPs for the cell edge terminals may be configured within the same RB set of a plurality of RB sets, and the BWPs for the cell center terminals may be configured within the same RB set of a plurality of RB sets.

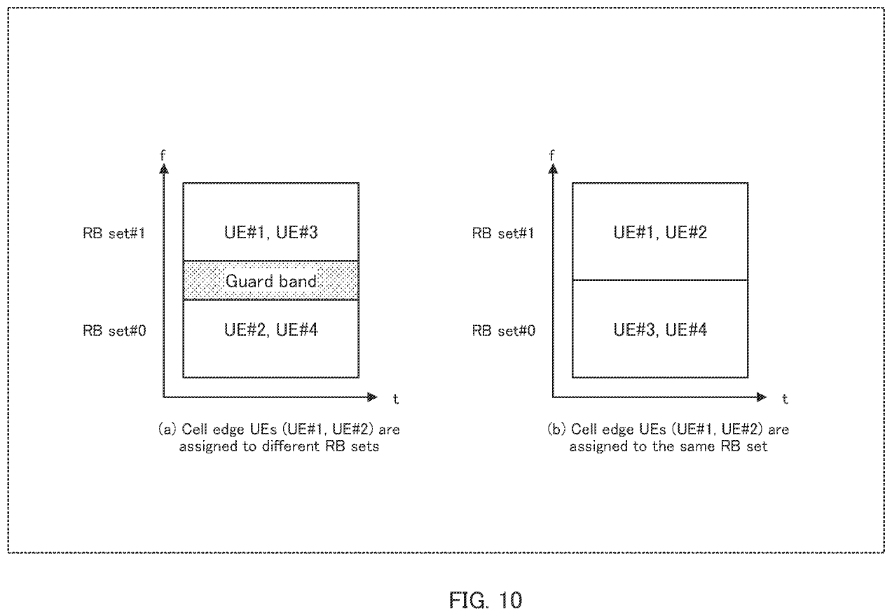

FIG. 10 illustrates an example of RB set allocation. Note that, similarly to FIG. 9, UE #1 and UE #2 represent cell edge terminals, and UE #3 and UE #4 represent cell center terminals in FIG. 10.

Part (a) in FIG. 10 illustrates an example in which a cell center terminal and a cell edge terminal are mixed in one RB set, and a different cell center terminal and a different cell edge terminal are assigned to each different RB set. In the case of part (a) in FIG. 10, as described above, the CLI between the cell edge terminals (between UE #1 and UE #2) is likely to increase, and thus, the guard band is placed to reduce the CLI. In the case of part (a) in FIG. 10, even though no guard band needs to be placed between the cell center terminals (between UE #3 and UE #4), resources that cannot be used are generated due to the guard band, which may lead to a reduction in resource utilization efficiency.

Part (b) in FIG. 10 illustrates an example in which the cell center terminal and the cell edge terminal are assigned respectively to different RB sets. For example, in part (b) in FIG. 10, cell center terminals (UE #3 and UE #4) are assigned to the same RB set #0, and cell edge terminals (UE #1 and UE #2) are assigned to the same RB set #1.

In part (b) in FIG. 10, the cell edge terminals are assigned to the same RB set. In the same RB set, the transmission direction configuration for the cell edge terminals is the same and does not differ. For this reason, no CLI is generated between the cell edge terminals assigned to RB set #1 (for example, between UE #1 and UE #2).

Thus, as illustrated in part (b) in FIG. 10, a guard band does not need to be placed between RB set #0 and RB set #1. Further, in part (b) in FIG. 10, a guard band smaller than that in part (a) in FIG. 10 may be placed between RB set #0 and RB set #1 (not illustrated). Thus, in the allocation shown in part (b) in FIG. 10, the resource utilization efficiency can be improved compared to part (a) in FIG. 10.

Note that, in the example described above, the positions of terminals 200 in the cell are classified into two stages, namely the cell edge and the cell center. However, the present disclosure is not limited to this, and may be classified into three or more stages.

Further, for example, the position of terminal 200 in the cell may be determined from the received power (for example, Reference Signal Received Power (RSRP) or the like) reported from terminal 200, the propagation delay amount, the RACH preamble type, or the like.

As described above, in classification method 1, the CLI can be easily addressed, and the resource utilization efficiency can be enhanced by varying the RB set allocated for terminal 200 according to the position of terminal 200.

### Classification Method 2

In classification method 2, subbands (for example, RB sets) allocated for terminal 200 may be classified according to the beam used for terminal 200 by base station 100, for example.

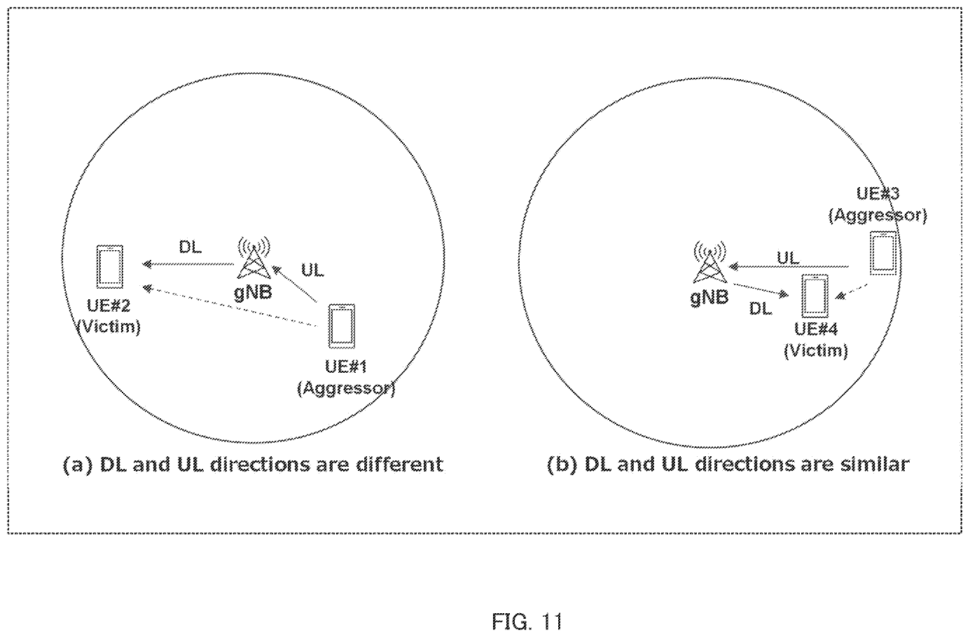

FIG. 11 shows an example of a beam direction used by base station 100 for terminal 200.

Part (a) in FIG. 11 illustrates an example in which the downlink beam direction and the uplink beam direction are different. In the case of part (a) in FIG. 11, even if UE #1 and UE #2 are classified into different RB sets, the CLI that UE #1 uplink transmission gives to UE #2 downlink reception is assumed to be small.

Accordingly, a BWP allocated for terminal 200 (for example, UE #2 in part (a) in FIG. 11) for which a first beam direction in the downlink is used and a BWP allocated for terminal 200 (for example, UE #1 in part (a) in FIG. 11) for which a second beam direction different from the first beam direction in the uplink is used may be configured in different RB sets among a plurality of RB sets. For example, in part (a) in FIG. 11, UE #1 and UE #2 may be classified into different groups of RB sets.

Part (b) in FIG. 11 illustrates an example in which the beam directions in the downlink and the uplink are the same (or are in close directions). In part (b) in FIG. 11, because UE #4 is located between the base station and UE #3 (for example, in the beam direction of the uplink of UE #3), in a case where UE #3 and UE #4 are classified into different RB sets, the uplink transmission of UE #3 may cause significant CLI to the downlink reception of UE #4.

Accordingly, a BWP allocated for terminal 200 (for example, UE #4 in part (b) in FIG. 11) for which the first beam direction in the downlink is used and a BWP allocated for terminal 200 (for example, UE #3) for which the first beam direction in the uplink is used may be configured within the same RB set among a plurality of RB sets. For example, in part (b) in FIG. 11, UE #3 and UE #4 may be classified into the same RB set group. Thus, for example, the transmission directions configuration for UE #3 and UE #4 are the same at the same timing and do not differ from each other, thereby preventing interference from the uplink transmission of UE #3 with the downlink reception of UE #4, and reducing CLI.

As described above, in classification method 2, terminals 200 for which the base station uses the same (or similar) beam direction for terminals 200 are classified into the same subband (RB set), which makes it easy to deal with CLI and also makes it possible to improve the resource utilization efficiency.

### Classification Method 3

In classification method 3, for example, the subband (for example, RB set) allocated for terminal 200 may be classified according to the amount of data transmission and reception in terminal 200.

For example, the ratio of the traffic amounts (data amounts) of the uplink and the downlink may differ depending on terminal 200. For example, in the same subband, it is assumed that terminal 200 cannot simultaneously transmit and receive in the uplink and the downlink, and that the uplink transmission and the downlink reception are time-divided.

In this case, for example, the same RB set may be allocated for terminal 200 for which the ratio of the traffic amounts in the uplink and downlink is the same (or similar). For example, the BWP allocated for terminal 200, where the ratio of the traffic amounts in the uplink and downlink is within a threshold range, may be configured in the same band among the plurality of RB sets. Thus, for example, the traffic requests for a plurality of terminals 200 (e.g., the ratio of the traffic amounts in the uplink and downlink to be time-divided) in the same RB set are likely to match, thereby enhancing the resource utilization efficiency (or scaling).

Note that, in classification method 3, the subbands allocated for terminals 200 may be classified in accordance with the traffic type (VoIP, video stream, and the like) without being limited to the traffic amount, for example.

As described above, in classification method 3, it is possible to improve resource utilization efficiency by classifying the subband (RB set) to be used by terminal 200 in accordance with the traffic amount of terminal 200 or the traffic type.

### Classification Method 4

In classification method 4, subbands (for example, RB sets) allocated for terminal 200 may be classified according to the coverage requirement in the uplink.

Terminal 200 (for example, a terminal that does not support a function for improving coverage, a terminal with low performance, or a terminal located at the cell edge) for which an improvement in uplink coverage is expected may be assigned to an RB set for which a long uplink transmission time is configured (for example, an RB set in which time resources (for example, slot or symbol) for the uplink are continuously placed). For example, the BWP allocated for terminal 200 that satisfies a condition relating to the coverage requirement may be configured within the same band among the plurality of RB sets. Examples of the condition relevant to the coverage requirement may include whether the terminal does not support a function for improving coverage, whether the terminal is a low-performance terminal, or whether the terminal is located at the cell edge.

For example, even when the size of the resource (for example, the number of resource elements) is the same, narrowing the frequency band and lengthening the transmission time is better than widening the frequency band and shortening the transmission time in terms of expanding the coverage of the uplink from the viewpoint of transmission power. Thus, it is possible to expand the coverage of the uplink for terminal 200 for which the RB set with a long uplink transmission time is allocated.

As described above, in classification method 4, terminal 200, for which the coverage improvement of the uplink is expected, is classified into a subband (RB set) in which the transmission time of the uplink is configured to be long, thereby improving the coverage of terminal 200.

### Classification Method 5

In classification method 5, the subband (for example, RB set) allocated for terminal 200 may be classified according to at least one of the uplink transmission occasion and the downlink reception occasion that are configured in a semi-static manner for terminal 200.

For example, the timing of transmission (for example, sounding reference signal (SRS), Configured grant, and the like) and reception (for example, channel state information reference signal (CSI-RS), control resource set (CORESET), and the like) that are configured in the semi-static manner in terminal 200 by higher layer signaling may differ between terminals 200.

In classification method 5, the BWP allocated for terminal 200, where the timing of the transmission occasion of at least one of the transmission and reception is the same, may be configured within the same RB set among the plurality of RB sets.

For example, when terminals 200 with substantially the same transmission and reception timings or frequencies are placed in the same RB set, the uplink and downlink transmission directions can be organized between terminals 200 in the RB set, thereby enhancing resource utilization efficiency.

As described above, in classification method 5, the subband (RB set) allocated for terminal 200 is classified according to at least one of the uplink transmission occasion and the downlink reception occasion configured in a semi-static manner for terminal 200, thereby enhancing resource utilization efficiency.

### Classification Method 6

In classification method 6, subbands (for example, RB sets) allocated for terminal 200 may be classified, for example, according to the CLI.

A BWP allocated for terminal 200 with a CLI equal to or greater than a threshold may be configured within the same RB set among a plurality of RB sets. For example, base station 100 may assign a combination of terminals 200, for which the CLI is high (for example, the CLI is equal to or greater than the threshold), to the same RB set, based on the CLI measured by terminals 200.

Note that the CLI measurement may be performed by, for example, CLI-Received signal strength indicator (CLI-RSSI), SRS-RSRP, CSI-RS measurement, or the like.

By assigning terminals 200 with a CLI equal to or greater than (or less than) the threshold to the same RB set, the CLI can be reduced. Further, as in classification method 1, the size of the guard band can also be reduced.

As described above, in classification method 6, the subbands allocated for terminal 200 are classified based on CLI, which facilitates dealing with CLI and can also improve resource utilization efficiency.

Classification methods 1 to 6 have been described above.

As described above, in allocation method 1 for the subband, the configuration of terminal 200 can be simplified and the resource utilization efficiency can be improved by, for example, facilitating dealing with CLI and by eliminating the need for control of a guard band, by configuring the frequency band allocated for terminal 200 within one subband (for example, in one RB set). In addition, the application of an RF filter in terminal 200 for CLI reduction can be simplified.

Further, in allocation method 1 of the subband, terminal 200 assigned to each of multiple subbands is classified according to the characteristics of terminal 200, which facilitates dealing with CLI and also improves resource utilization efficiency.

### Allocation Method 2

In allocation method 2, for example, base station 100 may determine whether to configure (or limit) a frequency band (for example, BWP) allocated for terminal 200 within one subband (for example, one RB set) according to a characteristic of terminal 200. For example, depending on the characteristic of terminal 200, base station 100 may determine (or switch) either allocation (for example, single subband allocation) in which the frequency band (for example, the allocation resource) allocated for terminal 200 is configured within one subband or allocation (for example, multiple subband allocation) in which the frequency band allocated for terminal 200 is configured to two or more subbands of the multiple subbands.

For example, by limiting the frequency band allocated for terminal 200 to one subband, it is possible to facilitate dealing with CLI as described in Allocation Method 1 and to improve resource utilization efficiency.

On the other hand, for example, a terminal with little influence from CLI (such as a terminal located at the cell center) may benefit from utilizing multiple subbands (for example, RB sets). For example, by allocating, for the uplink, some RB sets of the plurality of available RB sets always or for a long period, a longer uplink transmission time can be reserved, and an improvement in the coverage in the uplink can be expected. Further, for example, by, always or for a long period, allocating a part of the plurality of available RB sets for the uplink and allocating another part for the downlink, it is possible to shorten the delay time from the generation of traffic until transmission or the time for feedback, so as to reduce the transmission and reception delay time.

In Allocation Method 2, base station 100 may determine (or configure, change, or switch) whether to allocate multiple subbands or a single subband for terminal 200 according to a characteristic of terminal 200.

Hereinafter, an example of a method for determining the allocation of multiple subbands and the allocation of a single subband will be described.

### Determination Method 1

In determination method 1, base station 100 may determine the subband allocation for terminal 200, for example, according to the capability of the terminal (UE capability).

For example, terminal 200 may indicate to base station 100 whether the utilization of multiple subbands (RB sets) is possible for XDD. For example, when the performance of terminal 200 is low (for example, when the terminal cannot perform the guard band or RF filter switching process), terminal 200 may indicate (or report) to base station 100 that the terminal supports a single subband and does not support multiple subbands.

Base station 100 may determine, based on an indication (for example, the capability of terminal 200) from terminal 200, whether to allocate multiple subbands or to allocate a single subband for terminal 200.

Note that indication to base station 100 is not limited to the indication as to whether terminal 200 supports a single subband or multiple subbands, and terminal 200 may indicate to base station 100 the number of subbands that terminal 200 can support. In this case, base station 100 may determine the number of subbands allocated for terminal 200 in accordance with the number of supportable subbands indicated by terminal 200, for example.

As described above, in allocation method 1, the number of subbands allocated is determined according to the capability of terminal 200, and thus a terminal with a high capability can perform transmission and reception, which takes greater advantage of XDD (such as uplink coverage expansion or shortening of delay time). Further, for example, by applying a single subband allocation to terminal 200 with low capability, it is possible to perform transmission and reception using XDD while simplifying the processing of terminal 200 in the same manner as in allocation method 1.

### Determination Method 2

In determination method 2, base station 100 may determine the subband allocation for terminal 200 in accordance with the position of terminal 200 within the cell (for example, whether terminal 200 is located at the center of the cell or at the cell edge.

As described above, at the cell edge, CLI is likely to increase, and when multiple subbands are allocated for terminal 200, control becomes complicated, for example a guard band is placed between subbands, and the resource utilization efficiency decreases.

Base station 100 may determine, for example, a single subband allocation for a cell edge terminal (for example, a terminal at a position away from the cell center by a distance equal to or greater than a threshold), and may determine multiple subband allocations for a cell center terminal (for example, a terminal at a position away from the cell center by a distance less than the threshold).

Note that base station 100 may determine the position of terminal 200 from the cell center (or whether terminal 200 is a cell edge terminal) based on, for example, received power (such as RSRP), propagation delay amount, RACH preamble type, path loss, or the like (based on, for example, comparison with a threshold).

As described above, in allocation method 2, a single subband is allocated for the cell edge terminal, thereby preventing the control from becoming complicated due to CLI and resource utilization efficiency from decreasing, as in allocation method 1. Further, in allocation method 2, by allocating multiple subbands to the cell center terminal, transmission and reception that take advantage of the merits of XDD (for example, uplink coverage expansion or shortening of delay time) can be performed.

### Determination Method 3

In determination method 3, for example, base station 100 may determine subband allocation for terminal 200 according to the CLI.

As described above, the larger the CLI, the more likely a guard band will be placed between subbands when multiple subbands are allocated, and thus, the control of terminal 200 becomes complicated and the resource utilization efficiency decreases.

Base station 100 may determine whether to allocate multiple subbands according to the measured CLI, for example. For example, base station 100 may determine a single subband allocation for terminal 200 when the CLI is equal to or greater than the threshold, and may determine multiple subband allocation for terminal 200 when the CLI is smaller than the threshold.

Note that the CLI measurement may be performed by, for example, CLI-RSSI, SRS-RSRP, or CSI-RS measurement.

As described above, in allocation method 3, terminal 200 with a large CLI (for example, terminal 200 with a CLI equal to or greater than the threshold) is assigned to a single subband, and thus, it is possible to prevent the control of terminal 200 from becoming complicated and the resource utilization efficiency from being reduced, similarly to allocation method 1. Further, in allocation method 3, by assigning terminal 200 with a small CLI (for example, terminal 200 with a CLI less than a threshold) to multiple subbands, transmission and reception that take advantage of the merits of XDD (for example, uplink coverage expansion or shortening of delay time) can be performed.

Above, determination methods 1 to 3 have been described.

As described above, in subband allocation method 2, terminal 200 that utilizes a single subband and terminal 200 that utilizes multiple subbands are mixed. Thus, it is possible to, for example, perform transmission and reception taking advantage of the merit of XDD for terminal 200 that uses multiple subbands, while reducing the influence of CLI on terminal 200 that uses a single subband and it is thus possible to improve the performance of the system.

Above, an example of the subband allocation method has been described.

As described above, in the present embodiment, base station 100 and terminal 200 perform either signal transmission or signal reception by configuring a BWP allocated for the signal of terminal 200 within one subband of a plurality of subbands and using the allocated BWP, in a system (for example, XDD) in which the transmission direction is individually configured for each of a plurality of subbands (for example, RB sets) into which a frequency band (for example, a system band) is divided.

Thus, it is possible to appropriately configure allocation resources for reducing CLI and further improving resource utilization efficiency for terminal 200. Thus, according to the present embodiment, for example, XDD can be realized using the RB set.

### Other Embodiments

In the embodiment described above, the RAT to be supported does not necessarily have to be NR.

Further, the unit of resource in XDD where the frequency resource is divided is not limited to a subband or an RB set. A non-limiting and exemplary embodiment of the present disclosure may be applied to a mechanism for dividing system band. Additionally, the RB set may be referred to by another name.

Further, the frequency resource allocated for terminal 200 in the above-described embodiments is not limited to the BWP.

Furthermore, the values such as the number of RB sets and the number of terminals described in the embodiment are merely examples and are not limiting.

### Supplement

Information indicating whether or not terminal 200 supports the functions, operations, or processes described in the above-described embodiments may be transmitted (or indicated) from terminal 200 to base station 100 as, for example, capability information or capability parameters of terminal 200.

The capability information may include an information element (IE) indicating whether or not terminal 200 supports at least one of the functions, operations, or processes described in the above-described embodiments. Alternatively, the capability information may include an information element indicating whether or not terminal 200 supports a combination of any two or more of the functions, operations, or processes described in the above-described embodiments.

Based on, for example, capability information received from terminal 200, base station 100 may determine (or otherwise decide or assume) a function, operation, or process supported (or not supported) by terminal 200 which transmitted the capability information. Base station 100 may perform the operation, processing, or control according to a determination result based on the capability information. For example, base station 100 may control resource allocation for terminal 200 based on the capability information received from terminal 200.

Note that not supporting, by terminal 200, some of the functions, operations, or processes described in each of the above-described embodiments may be read as restrictions on some of such functions, operations, or processes in terminal 200. For example, information or requests regarding such restrictions may be indicated to base station 100.

The information regarding the capability or restrictions of terminal 200 may be defined, for example, in a standard, or may be implicitly indicated to base station 100 in association with information known to base station 100 or information transmitted to base station 100.

### Control Signal

In the present disclosure, the downlink control signal (or downlink control information) according to one exemplary embodiment of the present disclosure may be a signal (or information) transmitted in a Physical Downlink Control Channel (PDCCH) in a physical layer, for example, or may be a signal (or information) transmitted in a Medium Access Control Control Element (MAC CE) or a Radio Resource Control (RRC) in a higher layer. Further, the signal (or information) is not limited to that indicated by the downlink control signal, but may be predefined in the specifications (or standard) or may be pre-configured for the base station and the terminal.

In the present disclosure, the uplink control signal (or uplink control information) relating to the exemplary embodiment of the present disclosure may be, for example, a signal (or information) transmitted in a PUCCH of the physical layer or a signal (or information) transmitted in the MAC CE or RRC of the higher layer. In addition, the signal (or information) is not limited to a case of being indicated by the uplink control signal and may be previously specified by the specifications (or standards) or may be previously configured in a base station and a terminal. Further, the uplink control signal may be replaced with, for example, uplink control information (UCI), 1st stage sidelink control information (SCI), or 2nd stage SCI.

### Base Station

In one exemplary embodiment of the present disclosure, the base station may be a transmission reception point (TRP), a clusterhead, an access point, a remote radio head (RRH), an eNodeB (eNB), a gNodeB (gNB), a base station (BS), a base transceiver station (BTS), a base unit, or a gateway, for example. Furthermore, in the sidelink communication, the terminal may play a role of a base station. Further, instead of the base station, a relay apparatus that relays communication between a higher node and a terminal may be used. Moreover, a road side device may be used.

### Uplink/Downlink/Sidelink

One exemplary embodiment of the present disclosure may be applied to any of an uplink, downlink, and a sidelink, for example. For example, one exemplary embodiment of the present disclosure may be applied to a Physical Uplink Shared Channel (PUSCH), a Physical Uplink Control Channel (PUCCH), and a Physical Random Access Channel (PRACH) in the uplink, a Physical Downlink Shared Channel (PDSCH), PDCCH or a Physical Broadcast Channel (PBCH) in the downlink, or a Physical Sidelink Shared Channel (PSSCH), a Physical Sidelink Control Channel (PSCCH), a Physical Sidelink Broadcast Channel (PSBCH) in the sidelink.

The PDCCH, the PDSCH, the PUSCH, and the PUCCH are examples of a downlink control channel, a downlink data channel, an uplink data channel, and an uplink control channel, respectively. Further, the PSCCH and the PSSCH are examples of a sidelink control channel and a sidelink data channel, respectively. Further, the PBCH and the PSBCH are examples of a broadcast channel, and the PRACH is an example of a random access channel.

### Data Channels/Control Channels

One exemplary embodiment of the present disclosure may be applied to any of a data channel and a control channel, for example. For example, in one exemplary embodiment of the present disclosure, a channel in one exemplary embodiment of the present disclosure may be replaced with any of a PDSCH, a PUSCH, and a PSSCH for the data channel, or a PDCCH, a PUCCH, a PBCH, a PSCCH, and a PSBCH for the control channel.

### Reference Signals

In one exemplary embodiment of the present disclosure, the reference signals are, for example, signals known to both a base station and a mobile station and each reference signal may be referred to as a reference signal (RS) or sometimes a pilot signal. The reference signal may be any of a Demodulation Reference Signal (DMRS), a Channel State Information-Reference Signal (CSI-RS), a Tracking Reference Signal (TRS), a Phase Tracking Reference Signal (PTRS), a Cell-specific Reference Signal (CRS), or a Sounding Reference Signal (SRS).

### Time Intervals

In one exemplary embodiment of the present disclosure, the units of time resources are not limited to one or a combination of slots and symbols, but may be time resource units such as, for example, frames, superframes, subframes, slots, time slot subslots, minislots, or symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiments described above and may be other numbers of symbols.

### Frequency Band

One exemplary embodiment of the present disclosure may be applied to any of a licensed band and an unlicensed band.

### Communication

One exemplary embodiment of the present disclosure may be applied to any of communication between a base station and a terminal (Uu link communication), communication between a terminal and a terminal (Sidelink communication), and communication of a Vehicle to Everything (V2X). In one example, a channel in one exemplary embodiment of the present disclosure may be replaced with any of a PSCCH, a PSSCH, a Physical Sidelink Feedback Channel (PSFCH), a PSBCH, a PDCCH, a PUCCH, a PDSCH, a PUSCH, and a PBCH.

Further, one exemplary embodiment of the present disclosure may be applied to either of terrestrial networks or a non-terrestrial network (NTN) such as communication using a satellite or a high-altitude pseudolite (High Altitude Pseudo Satellite (HAPS)). Further, one exemplary embodiment of the present disclosure may be applied to a terrestrial network having a large transmission delay compared to the symbol length or slot length, such as a network with a large cell size and/or an ultra-wideband transmission network.

### Antenna Ports

In one exemplary embodiment of the present disclosure, the antenna port refers to a logical antenna (antenna group) configured of one or more physical antennae. For example, the antenna port does not necessarily refer to one physical antenna and may refer to an array antenna or the like configured of a plurality of antennae. In one example, the number of physical antennae configuring the antenna port may not be specified, and the antenna port may be specified as the minimum unit with which a terminal station can transmit a Reference signal. Moreover, the antenna port may be specified as the minimum unit for multiplying a weight of a Precoding vector.

### 5G NR System Architecture and Protocol Stack

3GPP has been working at the next release for the 5th generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of terminals (e.g., smartphones)

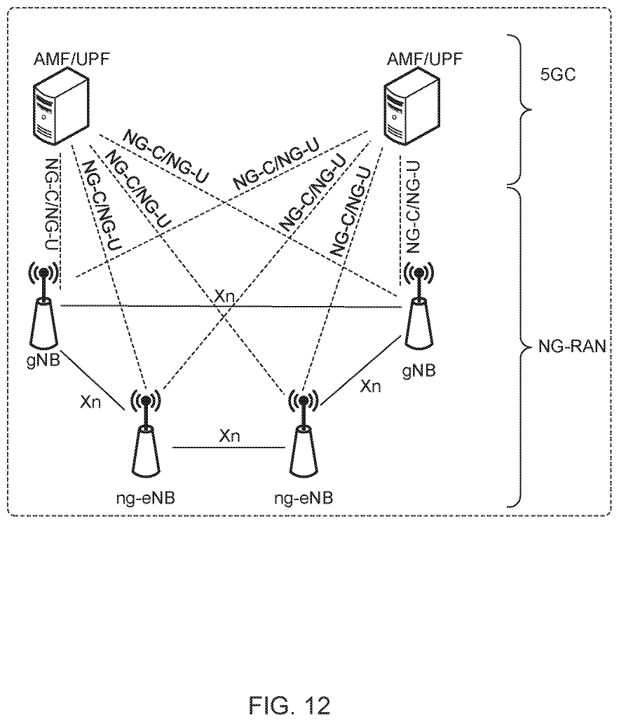

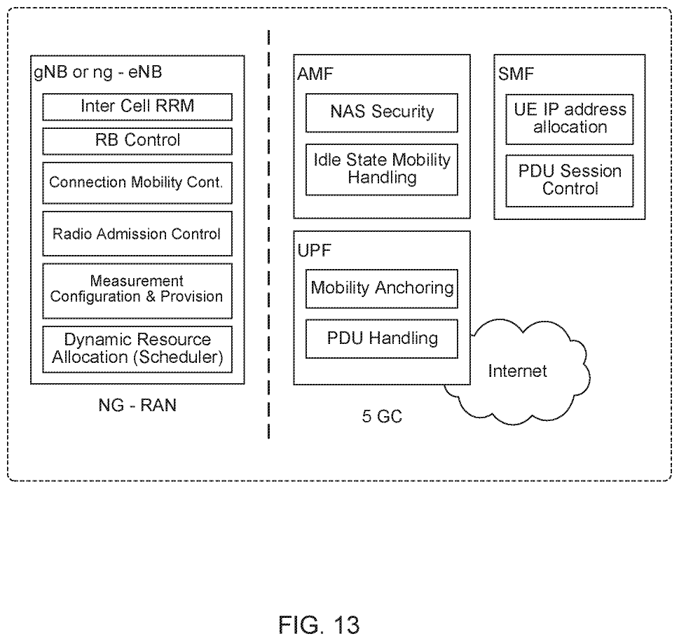

For example, the overall system architecture assumes an NG-RAN (Next Generation-Radio Access Network) that includes gNBs. The gNB provides the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 12 (see e.g., 3GPP TS 38.300 v15.6.0, section 4).

The user plane protocol stack for NR (see e.g., 3GPP TS 38.300, section 4.4.1) includes the PDCP (Packet Data Convergence Protocol, see clause 6.4 of TS 38.300), RLC (Radio Link Control, see clause 6.3 of TS 38.300) and MAC (Medium Access Control, see clause 6.2 of TS 38.300) sublayers, which are terminated in the gNB on the network side. Additionally, a new Access Stratum (AS) sublayer (SDAP, Service Data Adaptation Protocol) is introduced above the PDCP (see e.g., clause 6.5 of 3GPP TS 38.300). A control plane protocol stack is also defined for NR (see for instance TS 38.300, section 4.4.2). An overview of the Layer 2 functions is given in clause 6 of TS 38.300. The functions of the PDCP, RLC, and MAC sublayers are listed respectively in clauses 6.4, 6.3, and 6.2 of TS 38.300. The functions of the RRC layer are listed in clause 7 of TS 38.300.

For instance, the Medium Access Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. Examples of the physical channel include a Physical Random Access Channel (PRACH), a Physical Uplink Shared Channel (PUSCH), and a Physical Uplink Control Channel (PUCCH) as uplink physical channels, and a Physical Downlink Shared Channel (PDSCH), a Physical Downlink Control Channel (PDCCH), and a Physical Broadcast Channel (PBCH) as downlink physical channels.

Use cases/deployment scenarios for NR could include enhanced mobile broadband (eMBB), ultra-reliable low-latency communications (URLLC), and massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km2 in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacings of 15 kHz, 30 kHz, 60 kHz, and so forth. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grids is called a resource element and is identified based on the frequency index in the frequency domain and the symbol position in the time domain (see 3GPP TS 38.211 v15.6.0).

### Functional Split between NG-RAN and 5GC in 5G NR

FIG. 13 illustrates the functional split between the NG-RAN and the 5GC. NG-RAN logical node is a gNB or ng-eNB. The 5GC has logical nodes AMF, UPF and SMF.

For example, gNB and ng-eNB hosts the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or Operation, Admission, Maintenance (OAM));
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Function of Non-Access Stratum (NAS) signaling termination;
NAS signaling security;
Access Stratum, AS, Security control;
Inter-Core Network (CN) node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function (SMF) selection.

Furthermore, the User Plane Function, UPF, hosts the following main functions:
Anchor point for Intra-/Inter-RAT mobility (when applicable);
External Protocol Data Unit (PDU) session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Function of downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink data notification.

### RRC Connection Setup and Reconfiguration Procedure

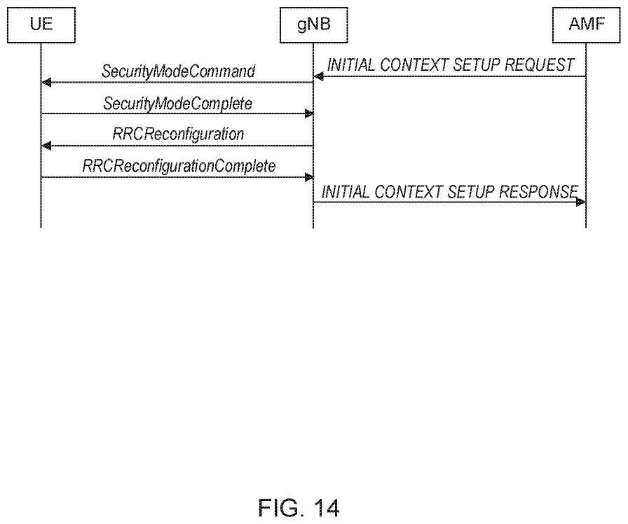

FIG. 14 illustrates some interactions between a UE, gNB, and AMF (a 5GC Entity) performed in the context of a transition of the UE from RRC_IDLE to RRC_CONNECTED for the NAS part (see TS 38 300 v15.6.0).

RRC is a higher layer signaling (protocol) used for UE and gNB configuration. With this transition, the AMF prepares UE context data (which includes, for example, a PDU session context, security key, UE Radio Capability, UE Security Capabilities, and the like) and sends it to the gNB with an INITIAL CONTEXT SETUP REQUEST. Then, the gNB activates the AS security with the UE. This activation is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not set up. Finally, the gNB informs the AMF that the setup procedure is completed with the INITIAL CONTEXT SETUP RESPONSE.

Thus, the present disclosure provides a 5th Generation Core (5GC) entity (e.g., AMF, SMF, or the like) including control circuitry, which, in operation, establishes a Next Generation (NG) connection with a gNodeB, and a transmitter, which in operation, transmits an initial context setup message to the gNodeB via the NG connection such that a signaling radio bearer between the gNodeB and a User Equipment (UE) is set up. Specifically, the gNodeB transmits Radio Resource Control (RRC) signaling including a resource allocation configuration Information Element (IE) to the UE via the signaling radio bearer. Then, the UE performs an uplink transmission or a downlink reception based on the resource allocation configuration.

### Usage Scenarios of IMT for 2020 and Beyond

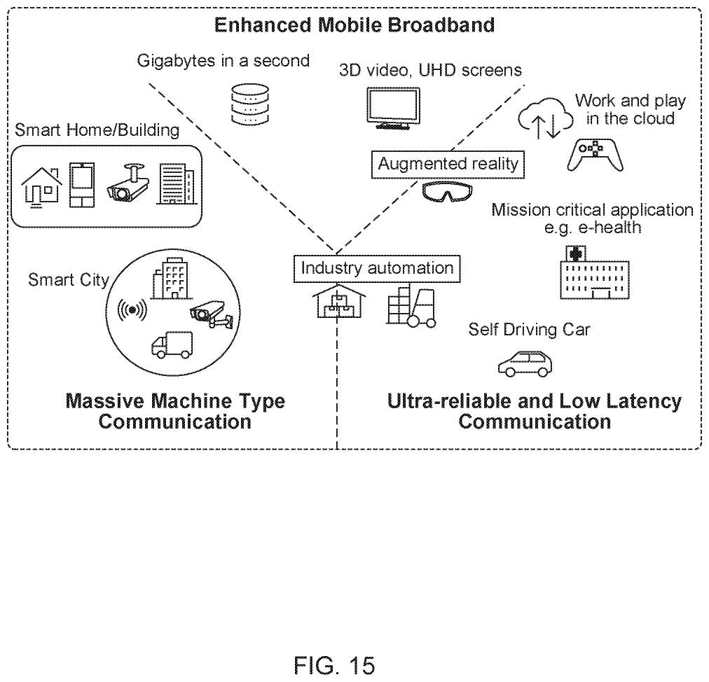

FIG. 15 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications (mMTC). FIG. 15 illustrates some examples of envisioned usage scenarios for IMT for 2020 and beyond (see e.g., ITU-R M.2083 FIG. 2).

The URLLC use case has stringent requirements for capabilities such as throughput, latency and availability. The URLLC use case has been envisioned as one of the enablers for future vertical applications such as wireless control of industrial manufacturing or production processes, remote medical surgery, distribution automation in a smart grid, transportation safety. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a block error rate (BLER) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, or the like. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, for example, for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization up to the extent of a few us (where the value can be one or a few us depending on frequency range and short latency on the order of 0.5 to 1 ms (in particular a target user plane latency of 0.5 ms), depending on the use cases).

Moreover, for NR URLLC, several technology enhancements from physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements are possible. The term “mini-slot” refers to a Transmission Time Interval (TTI) including a smaller number of symbols than a slot (a slot comprising fourteen symbols).

### QoS Control

The 5G QoS (Quality of Service) model is based on QoS flows and supports both Qos flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearer (DRB) together with the PDU Session, e.g., as illustrated above with reference to FIG. 14. Further, additional DRB(s) for QoS flow(s) of that PDU session can be subsequently configured (it is up to NG-RAN when to do so). The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

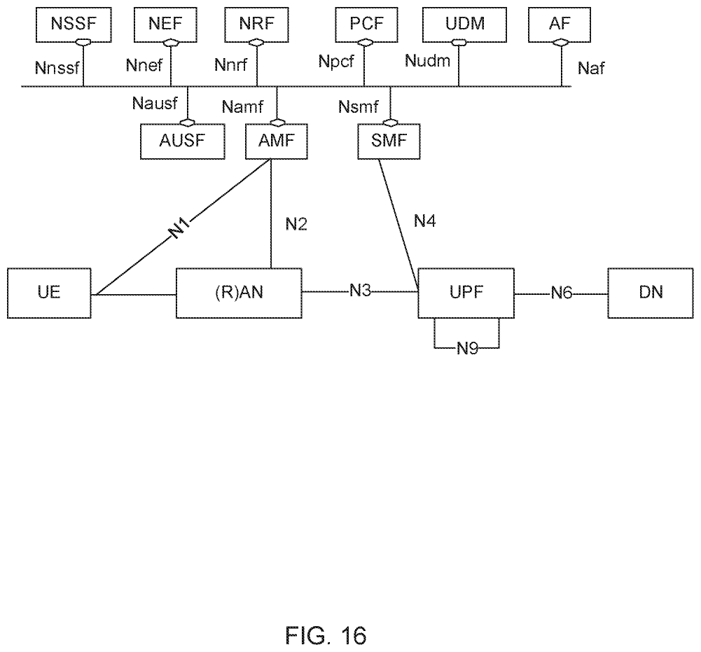

FIG. 16 illustrates a 5G NR non-roaming reference architecture (see TS 23.501 v16.1.0, section 4.23). An Application Function (AF), e.g., an external application server hosting 5G services, exemplarily described in FIG. 15, interacts with the 3GPP Core Network in order to provide services, for example to support application influence on traffic routing, accessing Network Exposure Function (NEF) or interacting with the Policy framework for policy control (see Policy Control Function, PCF), e.g., QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 16 illustrates further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), e.g., operator services, Internet access or 3rd party services. All of or a part of the core network functions and the application services may be deployed and running on cloud computing environments.

In the present disclosure, thus, an application server (for example, AF of the 5G architecture), is provided that includes: a transmitter, which, in operation, transmits a request containing a QoS requirement for at least one of URLLC, eMMB and mMTC services to at least one of functions (for example NEF, AMF, SMF, PCF, UPF, etc.) of the 5GC to establish a PDU session including a radio bearer between a gNodeB and a UE in accordance with the QoS requirement; and control circuitry, which, in operation, performs the services using the established PDU session.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI herein may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus. The communication apparatus may comprise a transceiver and processing/control circuitry. The transceiver may comprise and/or function as a receiver and a transmitter. The transceiver, as the transmitter and receiver, may include an RF (radio frequency) module and one or more antennas. The RF module may include an amplifier, an RF modulator/demodulator, or the like. Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT).”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

A base station according to one exemplary embodiment of the present disclosure includes: control circuitry, which, in operation, configures an allocation resource within one band of a plurality of bands into which a frequency band is divided, in a system in which a transmission direction is individually configured for each of the plurality of bands, the allocation resource being allocated for a signal of a terminal; and communication circuitry, which, in operation, performs either transmission or reception of the signal using the allocation resource.

In one exemplary embodiment of the present disclosure, the control circuitry determines the one band in accordance with a characteristic of the terminal.

In one exemplary embodiment of the present disclosure, the characteristic is a position of the terminal within a cell, and the allocation resource for the terminal whose position from a center of the cell is within a threshold range is configured within a same band of the plurality of bands.

In one exemplary embodiment of the present disclosure, the characteristic is a beam direction used for the terminal, and the allocation resource for the terminal for which a first beam direction in a downlink is used and the allocation resource for the terminal for which the first beam direction in an uplink is used are configured within a same band of the plurality of bands.

In one exemplary embodiment of the present disclosure, the allocation resource for the terminal for which the first beam direction in the downlink is used and the allocation resource for the terminal for which a second beam direction different from the first beam direction in the uplink is used are configured respectively within different bands of the plurality of bands.

In one exemplary embodiment of the present disclosure, the characteristic is a ratio of a data amount in a downlink and an uplink in the terminal, and the allocation resource for the terminal for which the ratio is within a threshold range is configured within a same band of the plurality of bands.

In one exemplary embodiment of the present disclosure, the characteristic is a coverage requirement in an uplink for the terminal, and the allocation resource for the terminal which satisfies a condition relating to the coverage requirement is configured within a same band of the plurality of bands.

In one exemplary embodiment of the present disclosure, the characteristic is at least one transmission occasion of a transmission and a reception for the terminal, and the allocation resource for the terminal with a same timing of the at least one transmission occasion is configured within a same band of the plurality of bands.

In one exemplary embodiment of the present disclosure, the characteristic is cross link interference, and the allocation resource for the terminal for which the cross link interference is equal to or larger than a threshold is configured within a same band of the plurality of bands.

In one exemplary embodiment of the present disclosure, the control circuitry determines either a first allocation in which the allocation resource is configured within the one band or a second allocation in which the allocation resource is configured within two or more bands of the plurality of bands, in accordance with a characteristic of the terminal.

In one exemplary embodiment of the present disclosure, the characteristic is a capability of the terminal, and the control circuitry determines either the first allocation or the second allocation based on the capability.

In one exemplary embodiment of the present disclosure, the characteristic is a position of the terminal in a cell, and the control circuitry determines the first allocation when the position is at a distance equal to or greater than a threshold from a center of the cell, or determines the second allocation when the position is at a distance less than the threshold from the center of the cell.

In one exemplary embodiment of the present disclosure, the characteristic is cross link interference, and the control circuitry determines the first allocation when the cross link interference is equal to or greater than a threshold, or determines the second allocation when the cross link interference is less than the threshold.

A terminal one exemplary embodiment of the present disclosure includes: control circuitry, which, in operation, configures an allocation resource within one band of a plurality of bands into which a frequency band is divided, in a system in which a transmission direction is individually configured for each of the plurality of bands, the allocation resource being allocated for a signal; and communication circuitry, which, in operation, performs either transmission or reception of the signal using the allocation resource.

In a communication method according to one exemplary embodiment of the present disclosure, a base station configures an allocation resource within one band of a plurality of bands into which a frequency band is divided, in a system in which a transmission direction is individually configured for each of the plurality of bands, the allocation resource being allocated for a signal of a terminal; and performs either transmission or reception of the signal using the allocation resource.

In a communication method according to one exemplary embodiment of the present disclosure, a terminal configures an allocation resource within one band of a plurality of bands into which a frequency band is divided, in a system in which a transmission direction is individually configured for each of the plurality of bands, the allocation resource being allocated for a signal; and performs either transmission or reception of the signal using the allocation resource.

The disclosure of Japanese Patent Application No. 2022-056373, filed on Mar. 30, 2022, including the specification, drawings and abstract, is incorporated herein by reference in its entirety.

### INDUSTRIAL APPLICABILITY

An exemplary embodiment of the present disclosure is useful for radio communication systems.

### REFERENCE SIGNS LIST

100 Base station
101, 201 Receiver
102, 202 Demodulator/decoder
103, 203 Measurer
104 Scheduler
105, 206 Control information holder
106, 204 Subband controller
107, 207 Data/control information generator
108, 208 Encoder/modulator
109, 209 Transmitter
200 Terminal
205 Controller

1. A base station, comprising:
control circuitry, which, in operation, configures an allocation resource within one band of a plurality of bands into which a frequency band is divided, in a system in which a transmission direction is individually configured for each of the plurality of bands, the allocation resource being allocated for a signal of a terminal; and
communication circuitry, which, in operation, performs either transmission or reception of the signal using the allocation resource.

2. The base station according to claim 1, wherein
the control circuitry determines the one band in accordance with a characteristic of the terminal.

3. The base station according to claim 2, wherein:
the characteristic is a position of the terminal within a cell, and
the allocation resource for the terminal whose position from a center of the cell is within a threshold range is configured within a same band of the plurality of bands.

4. The base station according to claim 2, wherein:
the characteristic is a beam direction used for the terminal, and
the allocation resource for the terminal for which a first beam direction in a downlink is used and the allocation resource for the terminal for which the first beam direction in an uplink is used are configured within a same band of the plurality of bands.

5. The base station according to claim 4, wherein
the allocation resource for the terminal for which the first beam direction in the downlink is used and the allocation resource for the terminal for which a second beam direction different from the first beam direction in the uplink is used are configured respectively within different bands of the plurality of bands.

6. The base station according to claim 2, wherein:
the characteristic is a ratio of a data amount in a downlink and an uplink in the terminal, and
the allocation resource for the terminal for which the ratio is within a threshold range is configured within a same band of the plurality of bands.

7. The base station according to claim 2, wherein:
the characteristic is a coverage requirement in an uplink for the terminal, and
the allocation resource for the terminal which satisfies a condition relating to the coverage requirement is configured within a same band of the plurality of bands.

8. The base station according to claim 2, wherein:
the characteristic is at least one transmission occasion of a transmission and a reception for the terminal, and
the allocation resource for the terminal with a same timing of the at least one transmission occasion is configured within a same band of the plurality of bands.

9. The base station according to claim 2, wherein:
the characteristic is cross link interference, and
the allocation resource for the terminal for which the cross link interference is equal to or larger than a threshold is configured within a same band of the plurality of bands.

10. The base station according to claim 1, wherein
the control circuitry determines either a first allocation in which the allocation resource is configured within the one band or a second allocation in which the allocation resource is configured within two or more bands of the plurality of bands, in accordance with a characteristic of the terminal.

11. The base station according to claim 9, wherein:
the characteristic is a capability of the terminal, and
the control circuitry determines either the first allocation or the second allocation based on the capability.

12. The base station according to claim 9, wherein:
the characteristic is a position of the terminal in a cell, and
the control circuitry determines the first allocation when the position is at a distance equal to or greater than a threshold from a center of the cell, or determines the second allocation when the position is at a distance less than the threshold from the center of the cell.

13. The base station according to claim 9, wherein:
the characteristic is cross link interference, and
the control circuitry determines the first allocation when the cross link interference is equal to or greater than a threshold, or determines the second allocation when the cross link interference is less than the threshold.

14. A terminal, comprising:
control circuitry, which, in operation, configures an allocation resource within one band of a plurality of bands into which a frequency band is divided, in a system in which a transmission direction is individually configured for each of the plurality of bands, the allocation resource being allocated for a signal; and
communication circuitry, which, in operation, performs either transmission or reception of the signal using the allocation resource.

15. A communication method by a base station, comprising:
configuring an allocation resource within one band of a plurality of bands into which a frequency band is divided, in a system in which a transmission direction is individually configured for each of the plurality of bands, the allocation resource being allocated for a signal of a terminal; and
performing either transmission or reception of the signal using the allocation resource.

16. A communication method by a terminal, comprising:
configuring an allocation resource within one band of a plurality of bands into which a frequency band is divided, in a system in which a transmission direction is individually configured for each of the plurality of bands, the allocation resource being allocated for a signal; and
performing either transmission or reception of the signal using the allocation resource.
